(19) United States
(12) Patent Application Publication
(10) Pub. No.: US 2017/0054957 A1
(43) Pub. Date: Feb. 23, 2017

(54) IMAGE DISPLAY DEVICE AND BLOWER FAN CONTROL METHOD

(71) Applicant: SONY CORPORATION, TOKYO (JP)

(72) Inventor: KAZUMASA IKEURA, TOKYO (JP)

(21) Appl. No.: 15/306,866

(22) PCT Filed: Mar. 10, 2015
(86) PCT No.: PCT/JP2015/056933

§ 371 Date: Oct. 26, 2016

(30) Foreign Application Priority Data
May 7, 2014 (JP) 2014-096326

(51) Int. Cl. H04N 9/31

(52) U.S. Cl. CPC H04N 9/3144

(57) ABSTRACT

[Object] To prevent air and heat from being retained inside the housing of a projector device.

[Solution] An image display device (100) includes: a light source (40); an optical system (20) that projects an image formed based on a light beam emitted by the light source (40) onto a projection surface; a plurality of blower fans (FAN_1 and FAN_2) respectively provided in at least two or more airflow paths that connect to an exhaust part inside a housing; an exhaust fan (FAN_3) provided in the exhaust part; and an airflow control unit (200) that controls a driving of the exhaust fan (FAN_3) in correspondence with driving control of a blower fan having a great airflow volume from among the plurality of blower fans (FAN_1 and FAN_2) provided in the airflow paths.

### CROSS REFERENCE TO RELATED APPLICATIONS

This application is a U.S. National Phase of International Patent Application No. PCT/JP2015/056933 filed on Mar. 10, 2015, which claims priority benefit of Japanese Patent Application No. JP 2014-096326 filed in the Japan Patent Office on May 7, 2014. Each of the above-referenced applications is hereby incorporated herein by reference in its entirety.

### TECHNICAL FIELD

The present disclosure relates to an image display device and a blower fan control method.

### BACKGROUND ART

Recently, projector devices are widely known as image display devices that display a projected image on a projection surface such as a screen. Projector devices are equipped with component parts that readily produce heat while being driven, such as a light source and power source, a voltage amplifier, and an image conversion element. Consequently, projector devices are equipped with blower fans. Patent Literature 1 below discloses technology that prevents sudden rises in the temperature of a light source lamp by measuring the temperature near the light source lamp of a projector device, and based on the measured temperature, performs feedback control of the rotation rate of a blower fan that sends air to the light source lamp.

### CITATION LIST

### Patent Literature

Patent Literature 1: JP 2009-69459A

### SUMMARY OF INVENTION

### Technical Problem

With a light source used in an image display device, there is a risk that the lifetime may be shortened or the light-emitting efficiency may be lowered due to the effects of temperature changes. Consequently, it is desirable to be able to avoid reductions in the cooling efficiency of a light source by a blower fan.

Accordingly, the present disclosure proposes a new and improved image display device and blower fan control method capable of preventing air and heat from being retained inside the housing of a projector device.

### Solution to Problem

According to the present disclosure, there is provided an image display device provided with: a light source; a projection optical system that projects an image formed on the basis of a light beam emitted by the light source onto a projection surface; a temperature sensor for detecting the temperature of the light source or near the light source; a blower fan for cooling the light source; and an airflow control unit that controls the driving of the blower fan based on the difference between the detected temperature and a target temperature.

Also, according to the present disclosure, there is provided a blower fan control method for a blower fan provided in an image display device that projects an image formed on the basis of a light beam emitted by a light source onto a projection surface, the method including: detecting the temperature of the light source or near the light source; and controlling the driving of the blower fan for cooling the light source, based on the difference between the detected temperature and a target temperature.

### Advantageous Effects of Invention

According to the present disclosure as described above, it becomes possible to prevent air and heat from being retained inside the housing of a projector device.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an exemplary diagrammatic configuration of a projector device according to an embodiment of the present disclosure.

FIG. 2 is an explanatory diagram illustrating airflow paths inside the housing of a projector device according to the embodiment.

FIG. 3 is an explanatory diagram illustrating an example configuration of an airflow control unit according to the embodiment.

FIG. 4 is an explanatory diagram illustrating the computational logic of an airflow control unit according to the embodiment.

FIG. 5 is a diagram for describing an offset value.

FIG. 6 is a graph illustrating the change in a detected light source temperature when performing PID control of a driving voltage of a first blower fan.

FIG. 7 is an explanatory diagram illustrating the relationship among ambient air temperature, a driving current of a light source, and a driving voltage of a second blower fan.

FIG. 8 is an explanatory diagram illustrating an example of changes in a driving voltage of an exhaust fan.

FIG. 9 is a flowchart illustrating an example process of a blower fan control method according to the embodiment.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Hereinafter, the description will proceed in the following order.

1. Exemplary diagrammatic configuration of projector device

2. Example configuration of airflow paths

3. Example configuration of airflow control unit

3.1. First blower fan control unit
3.1.1. Example process of first blower fan control
3.1.2. Relationship between driving voltage of first blower fan and temperature of light source

3.2. Second blower fan control unit

3.3. Exhaust fan control unit
3.3.1. Example process of exhaust fan control
3.3.2. Relationship between driving voltage of exhaust fan and temperature of light source

4. Example process of airflow control

5. Conclusion

### 1. EXEMPLARY DIAGRAMMATIC CONFIGURATION OF PROJECTOR DEVICE

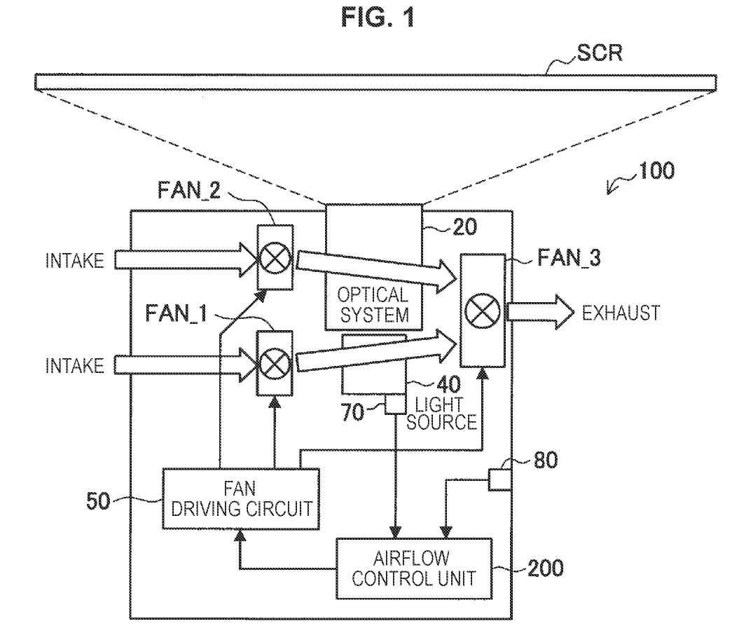

First, an image display device according to a first embodiment of the present disclosure will be described by taking a projector device as an example. FIG. 1 is an explanatory diagram illustrating an exemplary diagrammatic configuration of a projector device 100 according to the present embodiment. The projector device 100 is equipped with a light source 40, an optical system 20, an airflow control unit 200, and a fan driving circuit 50 inside a housing 90. In addition, the projector device 100 is equipped with a first blower fan FAN_1, a second blower fan FAN_2, and an exhaust fan FAN_3. Furthermore, the projector device 100 is equipped with a temperature sensor 70 and an ambient air temperature sensor 80.

The light source 40 is made up of a device such as a light-emitting element or a high-pressure mercury lamp, and is configured to emit a light beam towards the optical system 20. In the projector device 100 according to the present embodiment, a laser diode (LD), which is one mode of a light-emitting element, is used as the light source 40. Such an LD has a property of the emission efficiency lowering over the course of the usage period, and the temperature of the element when emitting radiant light at the same brightness rises as the emission efficiency lowers. Also, the wavelength of the light emitted from such an LD is temperature-dependent, and has a property in which the image quality changes depending on the element temperature, even if the driving current of the LD is the same.

Additionally, the light source 40 made up of an LD has a linear region in which the output (light intensity) may be varied continuously according to the current value, and by controlling the current value to supply, the output (light intensity) of the light source 40 is adjustable linearly or in multiple stages. Consequently, usage in which the output of the light source 40 is varied dynamically according to the ambient brightness around the projector device 100 is also possible, for example, and there is a risk that degradation in the light-emitting efficiency over time may occur more readily.

The optical system 20 may be configured with an illumination optical system and a projection optical system, for example. The illumination optical system may be configured as one that uniformly radiates a light beam emitted by the light source 40 onto the surface of an image-modulating element (liquid crystal panel) that acts as a primary image plane. Also, the projection optical system may be configured as one that receives radiant light from the illumination optical system, and enlarges and projects the image information of the primary image plane modulated by the liquid crystal panel of the illumination optical system onto a projection surface SCR that acts as a secondary image plane.

In other words, the projector device 100 according to the present embodiment modulates light emitted by the light source 40 made up of a LD with an image-modulating element, such as a liquid crystal display element or a digital micro-mirror device (DMD), to form an optical image corresponding to a picture signal. Additionally, the projector device 100 is configured as a short throw projector, and is configured to enlarge and project the formed optical image with the projection optical system for display on the projection surface. Such a projector device 100 may be configured as what is called a three-panel projector device equipped with panel display elements corresponding to each of the colors red (R), green (G), and blue (B).

Note that the short throw projector device 100 according to the present embodiment may be configured as one in which the projection optical system supports an ultra-wide angle, which is a half-angle of view of approximately 70°, for example. However, an image display device according to the present disclosure is not limited to a short throw projector device, and may also be a long throw projector device. In this case, various modifications to the configuration of the optical system are possible according the respective projector device.

The temperature sensor 70 is a sensor for detecting the temperature of the light source 40 or near the light source 40. In the present embodiment, the temperature sensor 70 is configured with a thermistor mounted near the light source 40 on the substrate on which the light source 40 is mounted. However, the temperature sensor 70 is not limited to a thermistor, and various types of sensors, such as a thermocouple or a non-contact temperature sensor, may also be used. Temperature information detected by the temperature sensor 70 is input into the airflow control unit 200.

The ambient air temperature sensor 80 is a sensor for detecting the temperature of the room in which the projector device 100 is installed. Temperature information detected by the ambient air temperature sensor 80 is input into the airflow control unit 200. The useable ambient air temperature sensor 80 is not particularly limited, insofar as detected ambient air temperature information may be transmitted to the airflow control unit 200. Besides equipping the projector device 100 with the ambient air temperature sensor 80, the airflow control unit 200 may also be configured to be able to receive ambient air temperature information from external equipment or the like.

The first blower fan FAN_1 is an air-sending device provided in a first airflow path for sending air to the light source 40. The second blower fan FAN_2 is an air-sending device provided in a second airflow path different from the first airflow path. The exhaust fan FAN_3 is an air-sending device that is provided at an exhaust outlet of the housing 90, and exhausts air from inside the housing 90 to the outside. Air flowing through the first airflow path and the second airflow path converges on the upstream side of the exhaust fan FAN_3, and is exhaust to the outside of the housing 90 by the exhaust fan FAN_3. Consequently, heat inside the housing 90 is released outside of the housing 90. These driving of these fans is controlled by the fan driving circuit 50, based on driving commands from the airflow control unit 200. Each of these fans may be configured using conventionally known fans.

### 2. EXAMPLE CONFIGURATION OF AIRFLOW PATHS

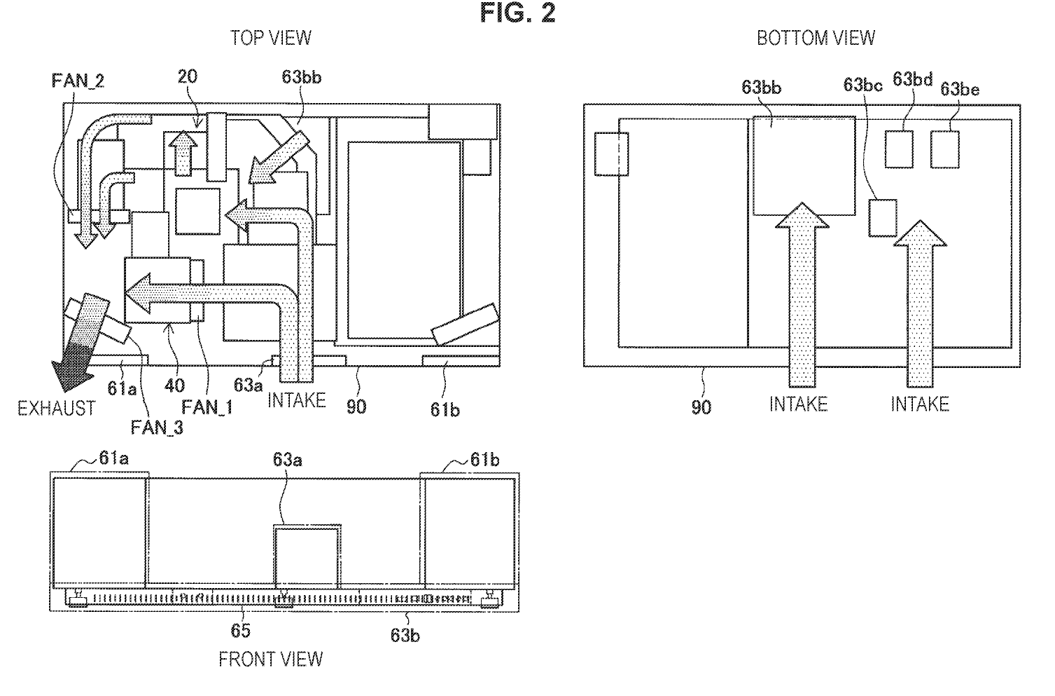

Next, an example configuration of airflow paths inside the housing 90 of the projector device 100 according to the present embodiment will be described with reference to FIG. 2. FIG. 2 illustrates perspective views from each of the top face and the bottom face of the housing 90 of the projector device 100, and a view from the front face (anterior face) of the housing 90.

The projector device 100 according to the present embodiment is configured to be able to project an image with the projection distance set to a very close distance, and is installed at a position close to the projection surface. In the top view and the bottom view illustrated in FIG. 2, the upper side is the projection surface side, while the lower side is the front face (anterior face) side where the user (viewer) is positioned.

The projector device 100 is equipped with an intake part 63a and exhaust parts 61a and 61b on the front face of the housing 90. The intake part 63a is an opening that takes in air into the inside of the housing 90 from the front face of the housing 90. The exhaust parts 61a and 61b are openings that exhaust air from the inside of the housing 90 to the outside of the housing 90. Additionally, the projector device 100 is equipped with intake parts 63ba, 63bb, 63bc, and 63bd on the bottom face of the housing 90. The intake parts 63ba, 63bb, 63bc, and 63bd are openings that take in air into the inside of the housing 90 from the bottom face of the housing 90. Air is guided into the intake parts 63ba, 63bb, 63bc, and 63bd primarily through a gap 63b on the lower part of the front face of the housing 90.

In this way, the projector device 100 is configured to take in air into the housing 90, and also exhaust air from the housing 90, on the front face side of the housing 90. Consequently, when the projector device 100 is assembled into a system together with devices such as speakers and a storage rack, even if devices such as the speakers are placed on both sides of the projector device 100, the efficiency of taking in and exhausting air is not lowered. This leads to increased freedom of layout for the projector system.

In addition, the projector device 100 according to the present embodiment is equipped with the first blower fan FAN_1 and the second blower fan FAN_2 inside the housing 90. Also, the projector device 100 is equipped with the exhaust fan FAN_3 inside the housing 90. In the present embodiment, the first blower fan FAN_1 is an air-sending device that sends air to the light source 40 and cools the light source 40. The second blower fan FAN_2 is an air-sending device that sends air to and cools components other than the light source 40, and additionally sends air blown by a blower fan not illustrated towards the exhaust part 61a. Also, the exhaust fan FAN_3 is an air-sending device that exhausts air primarily blown by the first blower fan FAN_1 and the second blower fan FAN_2 to the outside of the housing 90 from the exhaust part 61a.

In the projector device 100 according to the present embodiment, first and second airflow paths are provided. The first airflow path is a path for the flow of air sent towards the exhaust part 61a via the first blower fan FAN_1. Also, the second airflow path is a path for the flow of air sent towards the exhaust part 61a via the second blower fan FAN_2. In other words, of the first and second airflow paths that run to the exhaust part 61a, the first airflow path is an airflow path provided with the first blower fan FAN_1 for cooling the light source 40. In contrast, the second airflow path is an airflow path provided with multiple blower fans for cooling parts other than the light source 40.

Of these blower fans and exhaust fan, the driving of the first blower fan FAN_1 provided in the first airflow path is controlled by the airflow control unit 200 on the basis of temperature information detected by the temperature sensor 70. Also, the driving of the second blower fan FAN_2 provided in the second airflow path is controlled by the airflow control unit 200 on the basis of temperature information detected by the ambient air temperature sensor 80. Meanwhile, for the exhaust fan FAN_3, driving control is executed to match the driving control of the blower fan having the greater airflow volume from among the first blower fan FAN_1 and the second blower fan FAN_2.

Note that blower fans other than the first blower fan FAN_1 and the second blower fan FAN_2 may also be provided in the first airflow path and the second airflow path, respectively. However, the first blower fan FAN_1 and the second blower fan FAN_2 may be defined as the fans which are provided farthest downstream in each airflow path and which send air towards the exhaust part 61a.

### 3. EXAMPLE CONFIGURATION OF AIRFLOW CONTROL UNIT

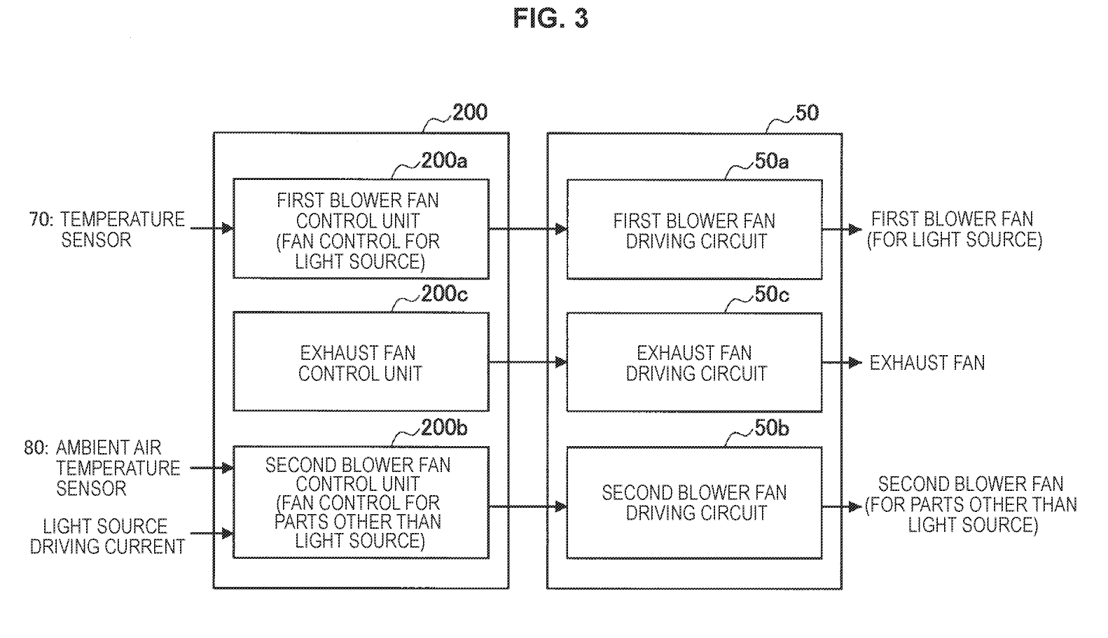

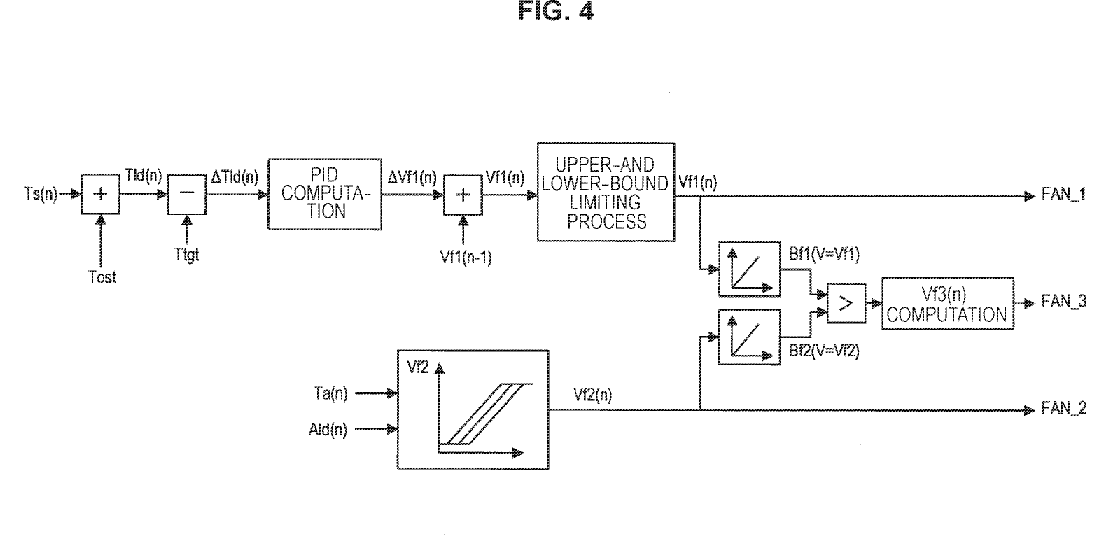

Next, an example configuration of the airflow control unit 200 of the projector device 100 according to the present embodiment will be described. FIG. 3 is an explanatory diagram using functional blocks to illustrate a configuration of the airflow control unit 200 and the fan driving circuit 50. Also, FIG. 4 is an explanatory diagram illustrating computational logic in the airflow control unit 200.

The airflow control unit 200 according to the present embodiment is equipped with a first blower fan control unit 200a, a second blower fan control unit 200b, and an exhaust fan control unit 200c. Specifically, these units are functions realized by a program executed by a microprocessor. Temperature information detected by the temperature sensor 70 and the ambient air temperature sensor 80 is input into the airflow control unit 200.

[3.1. First Blower Fan Control Unit]

(3.1.1. Example Process of First Blower Fan Control)

The first blower fan control unit 200a transmits, to a first blower fan driving circuit 50a, a driving control command for the first blower fan FAN_1 provided in the first airflow path and used to cool the light source 40. The first blower fan control unit 200a executes driving control of the first blower fan FAN_1 based on the difference between the temperature detected by the temperature sensor 70 and a certain target temperature.

In the projector device 100 according to the present embodiment, the first blower fan control unit 200a computes a temperature Tld of the portion where the light source 40 connects to the substrate (hereinafter, this temperature will also be called the “detected light source temperature”), based on a sensor-detected temperature Ts detected by the temperature sensor 70. Additionally, the first blower fan control unit 200a executes a PID computation based on the difference ΔTld between the detected light source temperature Tld and a target temperature Ttgt, and computes a driving voltage for the first blower fan FAN_1.

Specifically, as illustrated in FIG. 4, the first blower fan control unit 200a adds an offset value Tost to the sensor-detected temperature Ts(n) to compute the detected light source temperature Tld(n). Subsequently, the first blower fan control unit FAN_1 subtracts the target temperature Ttgt from the computed detected light source temperature Tld(n), and computes the difference ΔTld(n). In other words, the difference ΔTld(n) between the detected light source temperature Tld(n) and the target temperature Ttgt may be computed according to the following formula Math. 1.

[Math. 1]

ΔTld(n)=Ts(n)+Tost−Ttgt (1)

The offset value Tost is a value that corresponds to the differential temperature between the sensor-detected temperature Ts(n) and the detected light source temperature Tld(n) due to the difference between the position of the temperature sensor 70 and the position of the light source 40. In the present embodiment, the offset value Tost is a value that accounts for the distance between the light source 40 and the temperature sensor 70, and also the airflow volume of the first blower fan FAN_1. Of these, since the distance between the light source 40 and the temperature sensor 70 does not change, the offset value Tost becomes a variable value that varies according to the driving voltage Vf1 of the first blower fan FAN_1.

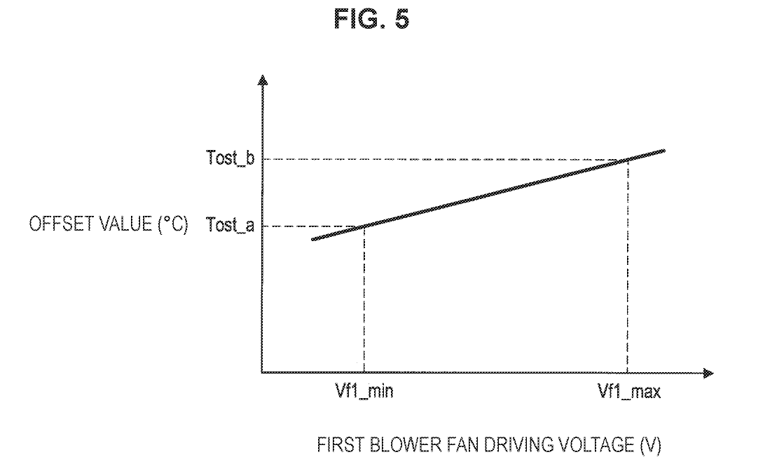

FIG. 5 is a diagram illustrating an example of how to compute the offset value Tost. In this example, real hardware was used in advance to measure offset values Tost_a and Tost_b from the sensor-detected temperature Ts with respect to the light source temperature Tld, corresponding to a maximum value Vf1_min and a minimum value Vf1_max of the driving voltage Vf1 of the first blower fan FAN_1. From these two points of measurement data, a relational expression between the driving voltage Vf1 and the offset value Tost is computed, and this relational expression is stored in advance in a storage element not illustrated in the airflow control unit 200. In the projector device 100 according to the present embodiment, the relational expression between the driving voltage Vf1 and the offset value Tost is an expression of a first-order function. Subsequently, the first blower fan control unit 200a computes the offset value Tost from the present driving voltage Vf1(n−1), based on the above relational expression.

However, the method of setting the offset value Tost is not limited to this example. Other factors that may influence the temperature difference additionally may be accounted for, or the offset value Tost may be treated as a tolerable value according to a tolerance range of the temperature difference.

Next, the first blower fan control unit FAN_1 conducts a PID computation based on the computed difference ΔTld(n), and computes the change ΔVf1(n) of the driving voltage. In the case of computing the driving voltage Vf1(n) by PID computation, the computational process expressed in the following Math. 2 may be conducted, for example.

[Math. 2]

Vf1(n)=Kp(ΔTld(n)−ΔTld(n−1))+Ki(ΔTld(n))+Kd((ΔTld(n)−ΔTld(n−1))−(ΔTld(n−1)−ΔTld(n−2))) (2)

Proportionality coefficient Kp=FAN_1_KP/100
Integral coefficient Ki=FAN_1_KI/100
Derivative coefficient Kd=FAN_1_KD/100

After the change ΔVf1(n) of the driving voltage is computed, the first blower fan control unit FAN_1 adds the change ΔVf1(n) to the previous driving voltage Vf1(n−1), and treats the result as the driving voltage Vf1 of the first blower fan FAN_1. In other words, the driving voltage Vf1(n) of the first blower fan FAN_1 is computed according to the following Math. 3.

[Math. 3]

Vf1(n)=Vf1(n−1)+ΔVf1(n) (3)

After that, the first blower fan control unit 200a of the airflow control unit 200 according to the present embodiment conducts an upper- and lower-bound limiting process that sets the driving voltage Vf1(n) computed according to the above Math. 3 within the range of the predetermined upper-bound value Vf1_max and lower-bound value Vf1_min. The lower-bound value Vf1_min of the driving voltage is the driving voltage Vf1 corresponding to the lowest output of the first blower fan FAN_1, and is set to drive the first blower fan FAN_1 at the lowest output or more. Meanwhile, the upper-bound value Vf1_max of the driving voltage is set so that the operating sound of the first blower fan FAN_1 does not become noisy and hearable by the user. Since the need to cool the light source 40 conceivably increases as the ambient air temperature detected by the ambient air temperature sensor 80 increases, such an upper-bound value Vf1_max may also be set to a larger value as the ambient air temperature rises.

In the upper- and lower-bound limiting process, if the computed driving voltage Vf1(n) exceeds the upper-bound value Vf1_max, the first blower fan control unit 200a sets the driving voltage Vf1(n) to the upper-bound value Vf1_max. Also, if the computed driving voltage Vf1(n) falls below the lower-bound value Vf1_min, the first blower fan control unit 200a sets the driving voltage Vf1(n) to the lower-bound value Vf1_min.

As above, the first blower fan control unit 200a computes the driving voltage Vf1(n) of the first blower fan FAN_1 at every computation interval, and transmits a driving command to the first blower fan driving circuit 50a based on the computed driving voltage Vf1(n).

(3.1.2. Relationship Between Driving Voltage of First Blower Fan and Temperature of Light Source)

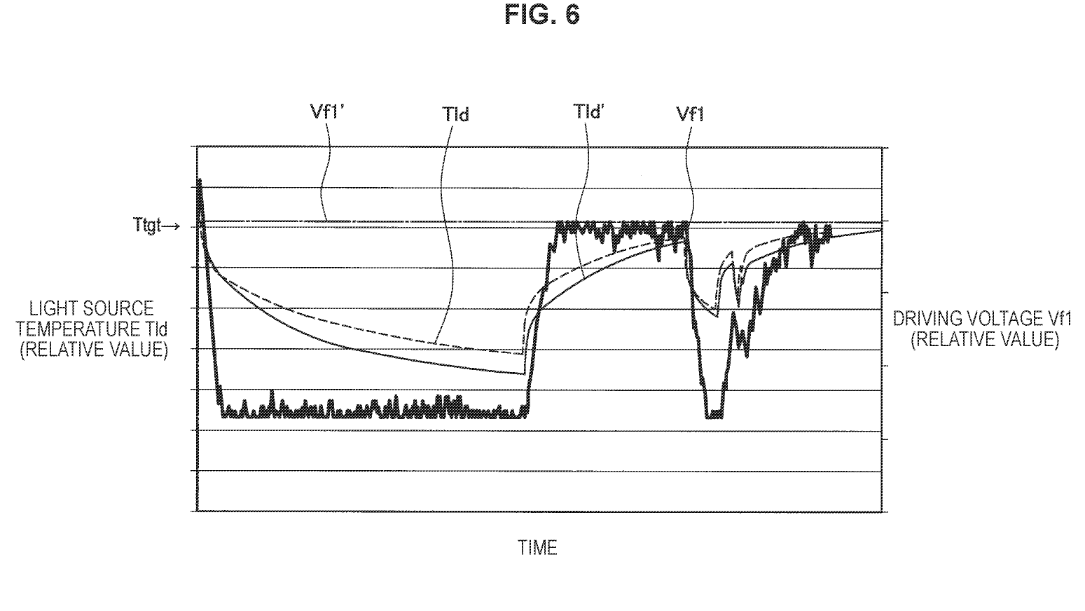

Next, the relationship between the driving voltage of the first blower fan FAN_1 and the temperature of the light source 40 will be described specifically. FIG. 6 illustrates an example of controlling the driving voltage Vf1 of the first blower fan FAN_1 in a state of varying the output (light intensity) of the light source 40 according to the ambient brightness around the projector device 100, and driving the blower fans other than the first blower fan FAN_1 as well as the exhaust fan at respectively fixed driving voltages.

In FIG. 6, the detected light source temperature Tld indicated by the dashed line indicates an example of conducting PID control of the driving voltage Vf1 of the first blower fan FAN_1 while varying the driving current Ald of the light source 40 over an output from 30% to 90%. Also, in FIG. 6, the detected light source temperature Tld′ indicated by the thin line indicates an example of keeping the first blower fan FAN_1 at a constant driving voltage Vf1′. In this example of FIG. 6, an upper-bound value Vf1_max and a lower-bound value Vf1_min of the driving voltage Vf1 are provided, and PID control of the driving voltage Vf1 is performed based on the difference ΔTld between the detected light source temperature Tld and the target temperature Ttgt.

As illustrated in FIG. 6, in the case of keeping the first blower fan FAN_1 at the constant driving voltage Vf1′, the detected light source temperature Tld′ varies according to the change in the driving current Ald of the light source 40. In contrast, in the case of performing PID control of the driving voltage Vf1′ of the first blower fan FAN_1 based on the difference ΔTld between the detected light source temperature Tld and the target temperature Ttgt, it is demonstrated that the detected light source temperature Tld indicated by the dashed line is brought closer to the target temperature Ttgt side than the detected light source temperature Tld′.

In this way, the first blower fan control unit 200a computes the detected light source temperature Tld based on the sensor-detected temperature Ts detected by the temperature sensor 70, and computes the difference ΔTld between the detected light source temperature Tld and the target temperature Ttgt. Subsequently, the first blower fan control unit 200a performs PID control of the driving voltage Vf1 of the first blower fan FAN_1 based on this difference ΔTld. Consequently, the first blower fan FAN_1 sends air to the light source 40 and cools the light source 40 while varying the airflow volume according to the temperature of the light source 40. As a result, the temperature of the light source 40 may be brought closer to the target temperature Ttgt.

Additionally, the first blower fan control unit 200a conducts an upper- and lower-bound limiting process on the driving voltage Vf1 computed by PID computation, and controls the driving voltage Vf1 of the first blower fan FAN_1 within a range of a preset upper-bound value Vf1_max and a lower-bound value Vf1_min. Consequently, incorrect operation of the first blower fan FAN_1 and the production of noise due to the operation of the first blower fan FAN_1 may be reduced.

As above, the first blower fan control unit 200a performs PID control of the driving voltage Vf1 of the first blower fan FAN_1, based on the difference ΔTld between the detected light source temperature Tld and the target temperature Ttgt. Consequently, it becomes possible to keep the temperature of the light source 40 near the target temperature Ttgt. As a result, drops in the light-emitting efficiency of the light source 40 are minimized, and the lifetime of the light source 40 may be extended. In addition, in the projector device 100 according to the present embodiment, a light-emitting element made up of an LD is used as the light source 40, and if the temperature of the light source 40 may be kept near the target temperature Ttgt, inconsistencies in the wavelength of the light that is output may be reduced. Consequently, more stable image quality may be achieved.

[3.2. Second Blower Fan Control Unit]

The second blower fan control unit 200b transmits, to a second blower fan driving circuit 50b, a driving control command for the second blower fan FAN_2 provided in the second airflow path. The second blower fan control unit 200b executes driving control of the second blower fan FAN_2 based on the temperature detected by the ambient air temperature sensor 80 and the present light source driving current Ald(n).

As illustrated in FIG. 4, in the projector device 100 according to the present embodiment, the second blower fan control unit 200b reads in the ambient air temperature Ta detected by the ambient air temperature sensor 80, and also reads in the present driving current Ald of the light source 40. The second blower fan control unit 200b computes the driving voltage Vf2 of the second blower fan FAN_2 based on a correlation among the ambient air temperature Ta, the driving current Ald of the light source 40, and the driving voltage Vf2 of the second blower fan FAN_2 that is computed and stored in advance.

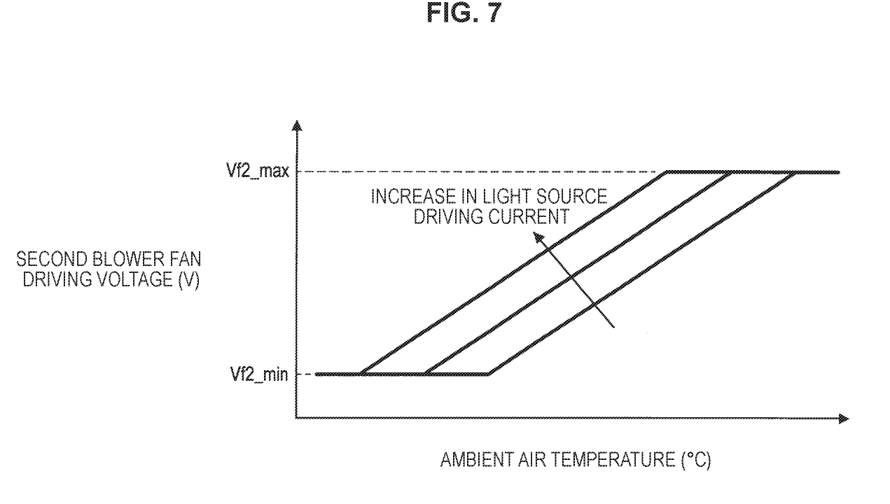

FIG. 7 illustrates an example of a correlation among the ambient air temperature Ta, the driving current Ald of the light source 40, and the driving voltage Vf2 of the second blower fan FAN_2. In this example, if the driving current Vf2 of the light source 40 is the same, the driving voltage Vf2 of the second blower fan FAN_2 increases as the ambient air temperature Ta rises. Also, if the ambient air temperature Ta is the same, the driving voltage Vf2 of the second blower fan FAN_2 increases as the driving current Vf2 of the light source 40 increases. However, in consideration of the lowest output of the second blower fan FAN_2 and the production of noise due to the operation of the second blower fan FAN_2, an upper-bound value Vf2_max and a lower-bound value Vf2_min on the driving voltage Vf2 of the second blower fan FAN_2 are decided.

In this way, the second blower fan control unit 200b computes the driving voltage Vf2 of the second blower fan FAN_2 based on the ambient air temperature Ta and the driving current Ald of the light source 40, and transmits a driving control command to the second blower fan driving circuit 50b.

[3.3. Exhaust Fan Control Unit]

(3.3.1. Example Process of Exhaust Fan Control)

The exhaust fan control unit 200c transmits a driving control command for the exhaust fan FAN_3 to an exhaust fan driving circuit 50c. The exhaust fan FAN_3 exhausts, to the outside of the housing 90, air flowing through the first airflow path that includes heat produced by the light source 40, and air flowing through the second airflow path that includes heat produced by components other than the light source 40. Consequently, to cool the inside of the housing 90 efficiently, it is necessary to exhaust the air flowing through each of the first airflow path and the second airflow path efficiently. Particularly, to keep the temperature of the light source 40 near the target temperature Ttgt and make the control performed by the first blower fan control unit 200a effective, it is necessary to exhaust air inside not only the first airflow path but also the second airflow path efficiently, and minimize rises in the air pressure inside the housing 90.

In the projector device 100 according to the present embodiment, the exhaust fan control unit 200c compares the airflow volume of the first blower fan FAN_1 provided in the first airflow path and the airflow volume of the second blower fan FAN_2 provided in the second airflow path. In other words, in the projector device 100, the airflow volume of the first blower fan FAN_1 may be regarded as the airflow volume flowing into the exhaust fan FAN_3 from the first airflow path. Also, the airflow volume of the second blower fan FAN_2 may be regarded as the airflow volume flowing into the exhaust fan FAN_3 from the second airflow path. Additionally, the exhaust fan control unit 200c controls the driving of the exhaust fan FAN_3 in correspondence with the driving control of the blower fan having the greater airflow volume.

Specifically, as illustrated in FIG. 4, the exhaust fan control unit 200c computes the airflow volume Bf1(V=Vf1) of the first blower fan FAN_1 from the driving voltage Vf1(n) of the first blower fan FAN_1 computed by the first blower fan control unit 200a. Also, the exhaust fan control unit 200c computes the airflow volume Bf2(V=Vf2) of the second blower fan FAN_2 from the driving voltage Vf2(n) of the second blower fan FAN_2 computed by the second blower fan control unit 200b. The relationship between the driving voltage Vf1 and the airflow volume Bf1 of the first blower fan FAN_1, and the relationship between the driving voltage Vf2 and the airflow volume Bf2 of the second blower fan FAN_2, are stored in advance in a device such as a storage element not illustrated.

The exhaust fan control unit 200c, after identifying the blower fan having the greater airflow volume from among the first blower fan FAN_1 and the second blower fan FAN_2, executes driving control of the second blower fan FAN_2 in correspondence with the driving control of the blower fan having the greater airflow volume. In the present embodiment, the exhaust fan control unit 200c is configured to compute a driving voltage Vf3(n) of the exhaust fan FAN_3 in correspondence with the control quantity of the blower fan having the greater airflow volume.

For example, if the rated output of the exhaust fan FAN_3 is greater than the rated output of the first blower fan FAN_1 and the second blower fan FAN_2, the driving voltage Vf1(n) (or Vf2(n)) of the respective blower fans may be used directly as the driving voltage Vf3 of the exhaust fan FAN_3. Alternatively, a coefficient may be applied to the driving voltage Vf1(n) (or Vf2(n)) of the respective blower fans according to the ratio of the rated output of the first blower fan FAN_1 or the second blower fan FAN_2 and the exhaust fan FAN_3, and the result may be treated as the driving voltage Vf3(n) of the exhaust fan FAN_3.

Consequently, the airflow volume of the exhaust fan FAN_3 becomes even larger than the larger airflow volume of either the airflow volume of the first blower fan FAN_1 or the airflow volume of the second blower fan FAN_2. Consequently, it is possible to prevent air from being retained on the upstream side of the exhaust fan FAN_3 and prevent the flow of air through the first airflow path at least from being impeded. Additionally, it is possible to prevent heat from being retained on the upstream side of the exhaust fan FAN_3 and prevent the cooling efficiency of the light source 40 by the first blower fan FAN_1 at least from falling. Furthermore, if the cooling efficiency of the light source 40 by the first blower fan FAN_1 can be maintained, it is possible to keep the temperature of the light source 40 near the target temperature Ttgt effectively by the first blower fan control unit 200a.

(3.3.2. Example of Change in Driving Voltage of Exhaust Fan)

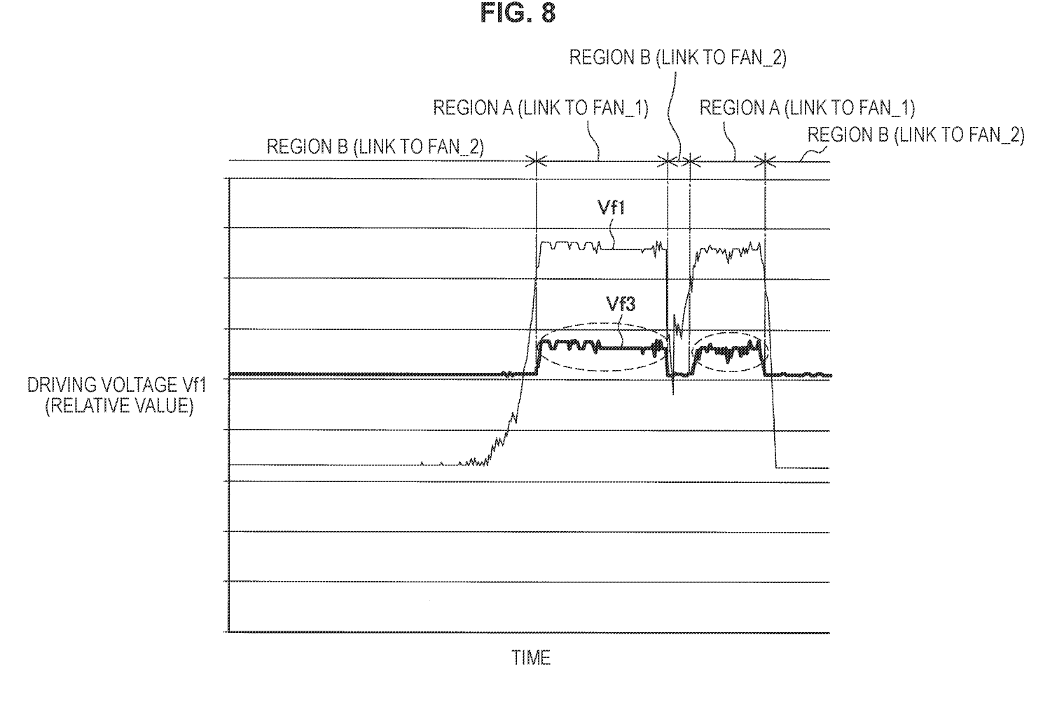

Next, an example of change in the driving voltage of the exhaust fan FAN_3 in the projector device 100 according to the present embodiment will be described specifically. FIG. 8 illustrates change in the driving voltage Vf3 of the exhaust fan FAN_3 in a state of controlling the driving voltage Vf3 of the exhaust fan FAN_3 in correspondence with the driving control of the blower fan having the greater airflow volume from either the first blower fan FAN_1 or the second blower fan FAN_2. In FIG. 8, the thin line indicates the driving voltage Vf1 of the first blower fan FAN_1, while the thick line indicates the driving voltage Vf3 of the exhaust fan FAN_3.

The example in FIG. 8 is an example of the case of varying the output (light intensity) of the light source 40 in a state in which the ambient air temperature Ta is nearly constant. The driving voltage Vf1 of the first blower fan FAN_1 is PID controlled according to the difference ΔTld between the detected light source temperature Tld and the target temperature Ttgt. In FIG. 8, the region A is the region in which the airflow volume Bf1 of the first blower fan FAN_1 is greater than the airflow volume Bf2 of the second blower fan FAN_2. Also, the region B is the region in which the airflow volume Bf2 of the second blower fan FAN_2 is greater than the airflow volume Bf1 of the first blower fan FAN_1. Consequently, the driving voltage Vf3 of the exhaust fan FAN_3 is controlled in correspondence with the driving control of the first blower fan FAN_1 in the region A, and controlled in correspondence with the driving control of the second blower fan FAN_2 in the region B.

As illustrated in FIG. 8, in the present embodiment, if the detected light source temperature Tld rises, and the airflow volume Bf1 of the first blower fan FAN_1 becomes greater than the airflow volume Bf2 of the second blower fan FAN_2, the driving voltage Vf3 of the exhaust fan FAN_3 increases correspondingly. Consequently, the airflow volume exhausted outside the housing 90 by the exhaust fan FAN_3 increases, and the risk of air and heat being retained on the upstream side of the exhaust fan FAN_3 may be reduced. As a result, reductions in the cooling efficiency of each component part in the first airflow path and the second airflow path may be prevented. In particular, in the projector device 100 according to the present embodiment, the detected light source temperature Tld is more easily kept near the target temperature Ttgt.

### 4. EXAMPLE PROCESS OF AIRFLOW CONTROL

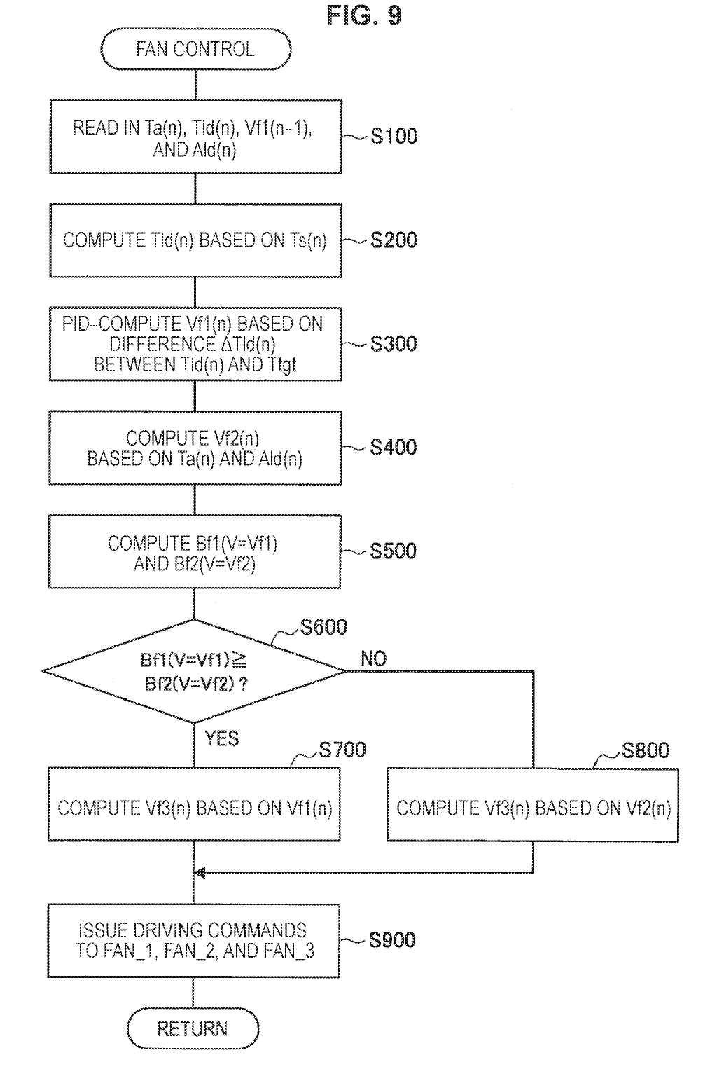

Next, a specific example process of airflow control executed by the airflow control unit 200 according to the present embodiment will be described. FIG. 9 is a flowchart illustrating an example of a blower fan control process in the projector device 100 according to the present embodiment. This flowchart illustrates driving control of the first blower fan FAN_1, the second blower fan FAN_2, and the exhaust fan FAN_3.

First, in step S100, the airflow control unit 200 reads in the ambient air temperature Ta(n) detected by the ambient air temperature sensor 80, the sensor-detected temperature Ts(n) detected by the temperature sensor 70, the present driving voltage Vf1(n−1) of the first blower fan FAN_1, and the present driving current Ald(n) of the light source 40. Next, in step S200, the airflow control unit 200 computes the detected light source temperature Tld(n) based on the sensor-detected temperature Ts(n), following the procedure already described with reference to FIG. 4.

Next, in step S300, the airflow control unit 200 performs PID computation of the driving voltage Vf1(n) of the first blower fan FAN_1 based on the difference ΔTld(n) between the detected light source temperature Tld(n) and the target temperature Ttgt, following the procedure already described with reference to FIG. 4. At this point, if the computed driving voltage Vf1(n) exceeds the preset upper-bound value Vf1_max, the upper-bound value Vf1_max may be set as the driving voltage Vf1(n). Also, if the computed driving voltage Vf1(n) falls below the preset lower-bound value Vf1_min, the lower-bound value Vf1_min may be set as the driving voltage Vf1(n).

Next, in step S400, the airflow control unit 200 references correlation information stored in advance, and computes the driving voltage Vf2(n) of the second blower fan FAN_2 based on the ambient air temperature Ta(n) and the driving current Ald(n) of the light source 40.

Next, in step S500, the airflow control unit 200 computes the airflow volume Bf1(V=Vf1) of the first blower fan FAN_1 and the airflow volume Bf2(V=Vf2) of the second blower fan FAN_2, based on the computed driving voltages Vf1(n) and Vf2(n). Next, in step S600, the airflow control unit 200 determines whether or not the airflow volume Bf1(V=Vf1) of the first blower fan FAN_1 is equal to or greater than the airflow volume Bf2(V=Vf2) of the second blower fan FAN_2.

If the airflow volume Bf1(V=Vf1) of the first blower fan FAN_1 is equal to or greater than the airflow volume Bf2(V=Vf2) of the second blower fan FAN_2 (S600: Yes), the flow proceeds to step S700. In step S700, the airflow control unit 200 computes the driving voltage Vf3(n) of the exhaust fan FAN_3 in correspondence with the driving voltage Vf1(n) of the first blower fan FAN_1. On the other hand, if the airflow volume Bf1(V=Vf1) of the first blower fan FAN_1 is less than the airflow volume Bf2(V=Vf2) of the second blower fan FAN_2 (S600: No), the flow proceeds to step S800. In step S800, the airflow control unit 200 computes the driving voltage Vf3(n) of the exhaust fan FAN_3 in correspondence with the driving voltage Vf2(n) of the first blower fan FAN_2.

After the driving voltage Vf3(n) of the exhaust fan FAN_3 is computed, in step S900, the airflow control unit 200 transmits a driving command to the driving circuit of each of the first blower fan FAN_1, the second blower fan FAN_2, and the exhaust fan FAN_3.

According to the blower fan control method according to the present embodiment described above, the driving of the exhaust fan FAN_3 is controlled in correspondence with the driving control of the blower fan having the greater airflow volume from among the first blower fan FAN_1 provided in the first airflow path and used to cool the light source 40, and the second blower fan FAN_2 provided in the second airflow path that converges with the first airflow path. Consequently, it is possible to prevent air and heat from being retained on the upstream side of the exhaust fan FAN_3. As a result, the cooling efficiency by the blower fans provided in the first airflow path and the second airflow path inside the housing 90 may be maintained favorably.

In addition, according to the blower fan control method according to the present embodiment, the first blower fan FAN_1 used to cool the light source 40 is PID-controlled based on the difference ΔTld(n) between the detected light source temperature Tld and the target temperature Ttgt. Consequently, the temperature of the light source 40 may be kept near the target temperature Ttgt. For this reason, drops in the light-emitting efficiency of the light source 40 may be minimized, and the light intensity of the light source 40 may be stabilized. Also, since air and heat are not retained on the upstream side of the exhaust fan FAN_3, through control of the first blower fan FAN_1 by the first blower fan control unit 200a, control to keep the temperature of the light source 40 near the target temperature Ttgt may be performed efficiently. As a result, the lifetime of the light source 40 potentially may be extended, and in addition, good image quality may be maintained.

### 5. CONCLUSION

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the foregoing embodiment is described by taking the example of a short throw projector device, but the present disclosure is not limited thereto. For example, the technology of the present disclosure may also be applied to a long throw projector device.

Additionally, in the foregoing embodiment, the exhaust fan control unit 200c computes the driving voltage Vf3 of the exhaust fan by utilizing the value of the driving voltage of the blower fan having the greater airflow volume, but the present disclosure is not limited thereto. For example, after identifying the driving voltage of the blower fan having the greater airflow volume, the exhaust fan control unit 200c may also execute the computation of the driving voltage Vf3 independently, based on detected temperature information from the temperature sensor 70 or the ambient air temperature sensor 80.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An image display device, including:

a light source;

an optical system that projects an image formed based on a light beam emitted by the light source onto a projection surface;

a plurality of blower fans respectively provided in at least two or more airflow paths that connect to an exhaust part inside a housing;

an exhaust fan provided in the exhaust part; and

an airflow control unit that controls a driving of the exhaust fan in correspondence with driving control of a blower fan having a great airflow volume from among the plurality of blower fans provided in the airflow paths.

(2)

The image display device according to (1), wherein

the airflow control unit sets an airflow volume of the exhaust fan equal to or greater than the great airflow volume from among the airflow volumes of the plurality of blower fans.

(3)

The image display device according to (1) or (2), wherein

the plurality of blower fans include a first blower fan for cooling the light source, and a second blower fan for cooling parts other than the light source.

(4)

The image display device according to (3), including:

a temperature sensor that detects a temperature of the light source or near the light source, wherein

the airflow control unit controls a driving of the first blower fan in a manner that the detected temperature becomes a target temperature.

(5)

The image display device according to (3) or (4), including:

an ambient air temperature sensor that detects an ambient air temperature around the image display device, wherein

the airflow control unit controls a driving of the second blower fan according to the detected ambient air temperature.

(6)

The image display device according to any one of (1) to (5), wherein

the light source is made of a light-emitting element.

(7)

The image display device according to any one of (1) to (6), wherein

the image display device is an image display device in which a focal length of a projected image to be projected onto the projection surface is configurable to a close distance, and

the exhaust part is provided, from among side faces of the housing, on a side face different from a side face in a projection direction of the projected image.

(8)

A blower fan control method, including:

controlling a driving of an exhaust fan provided in an exhaust part, in correspondence with driving control of a blower fan having a great airflow volume from among a plurality of blower fans respectively provided in at least two or more airflow paths that connect to the exhaust part inside a housing of an image display device.

### REFERENCE SIGNS LIST

20 optical system
40 light source
50 fan driving circuit
50a first blower fan driving circuit
50b second blower fan driving circuit
50c exhaust fan driving circuit
61a, 61b exhaust part
63a intake part
63b gap
63ba, 63bb, 63bc, 63bd intake part
70 temperature sensor
80 ambient air temperature sensor
90 housing
100 projector device
200 airflow control unit
200a first blower fan control unit
200b second blower fan control unit
200c exhaust fan control unit

1. An image display device, comprising:
a light source;
an optical system that projects an image formed based on a light beam emitted by the light source onto a projection surface;
a plurality of blower fans respectively provided in at least two or more airflow paths that connect to an exhaust part inside a housing;
an exhaust fan provided in the exhaust part; and
an airflow control unit that controls a driving of the exhaust fan in correspondence with driving control of a blower fan having a great airflow volume from among the plurality of blower fans provided in the airflow paths.

2. The image display device according to claim 1, wherein
the airflow control unit sets an airflow volume of the exhaust fan equal to or greater than the great airflow volume from among the airflow volumes of the plurality of blower fans.

3. The image display device according to claim 1, wherein
the plurality of blower fans include a first blower fan for cooling the light source, and a second blower fan for cooling parts other than the light source.

4. The image display device according to claim 3, comprising:
a temperature sensor that detects a temperature of the light source or near the light source, wherein
the airflow control unit controls a driving of the first blower fan in a manner that the detected temperature becomes a target temperature.

5. The image display device according to claim 3, comprising:
an ambient air temperature sensor that detects an ambient air temperature around the image display device, wherein
the airflow control unit controls a driving of the second blower fan according to the detected ambient air temperature.

6. The image display device according to claim 1, wherein
the light source is made of a light-emitting element.

7. The image display device according to claim 1, wherein
the image display device is an image display device in which a focal length of a projected image to be projected onto the projection surface is configurable to a close distance, and
the exhaust part is provided, from among side faces of the housing, on a side face different from a side face in a projection direction of the projected image.

8. A blower fan control method, comprising:
controlling a driving of an exhaust fan provided in an exhaust part, in correspondence with driving control of a blower fan having a great airflow volume from among a plurality of blower fans respectively provided in at least two or more airflow paths that connect to the exhaust part inside a housing of an image display device.
